(19) United States
(12) Patent Application Publication
(10) Pub. No.: US 2026/0321081 A1
(43) Pub. Date: Oct. 15, 2026

(54) METHOD AND APPARATUS FOR CONTROLLING SIGNALS IN ACCESS CONTROL SYSTEM

(71) Applicant: HANWHA VISION CO., LTD., Seongnam-si (KR)

(72) Inventors: Wonju JEONG, Seongnam-si (KR); Matthew NETARDUS, Seongnam-si (KR)

(73) Assignee: HANWHA VISION CO., LTD., Seongnam-si (KR)

(21) Appl. No.: 19/328,731

(22) Filed: Sep. 15, 2025

(30) Foreign Application Priority Data
Apr. 8, 2025 (KR) 10-2025-0045467

(51) Int. Cl. G07C 9/30; G06F 13/20

(52) U.S. Cl. CPC G07C 9/30; G06F 13/20; G06F 2213/40

(57) ABSTRACT

Provided is a method and apparatus for controlling signals in an access control system, the method including: identifying a communication protocol used by a reader upon receiving identification information from the reader disposed in a designated area, setting an operation mode to one of a plurality of modes based on the communication protocol of the reader; determining whether to convert at least some of signal lines connected as output ports among a plurality of signal lines into input ports based on the set operation mode and setting a switching direction of a control logic circuit; and inputting or outputting data required for a user's access verification procedure to the designated area through a path formed by the set switching direction.

### CROSS-REFERENCE TO RELATED APPLICATIONS

This application claims the priority of Korean Patent Application No. 10-2025-0045467, filed on Apr. 8, 2025, in the Korean Intellectual Property Office, the disclosure of which is incorporated herein in its entirety by reference.

### BACKGROUND

The present disclosure relates to a method and apparatus for controlling signals in an access control system.

In general, entities requiring strict security, such as corporations, government agencies, public institutions, and research facilities, must rigorously manage visitors' access to buildings or designated areas to prevent leakage of internal assets or information to the outside.

As communication technologies have rapidly advanced in recent years, security environments based on various communication protocols have been increasingly adopted for these access control systems.

The description of the background art is provided to facilitate a better understanding of the present disclosure. It should not be construed as an acknowledgment that the information contained herein constitutes prior art.

### SUMMARY

Conventionally, when a visitor enters a building or a restricted area occupied by an entity such as a corporation, government agency, public institution, or research facility, the visitor is required to manually fill out or electronically input personal information into a device such as a reader, which is an data collector, the purpose of the visit, the time of entry, and the like. A visitor badge or access card is then issued to permit entry into the designated area.

In such cases, the visitor may gain entry either by presenting the visitor badge or access card to a security officer for verification or by directly contacting the card or fingerprint on the reader.

In the latter case, various communication protocols have been developed to support access control systems, among which Wiegand and Open Supervised Device Protocol (OSDP) are widely used as the main communication protocols among a plurality of communication protocols or modes. These Wiegand protocol and OSDP protocol differ primarily in the method of data transmission between the reader and a controller.

Here, Wiegand is a communication protocol that sends data from the reader to the controller and is designed to simply process user's access information. In contrast, OSDP is designed to allow the reader and the controller to exchange data interactively, thereby overcoming the limitations of Wiegand. In other words, Wiegand performs unidirectional communication, whereas OSDP performs bidirectional communication.

Although Wiegand and OSDP were designed with different objectives, both communication protocols are being applied in combination to ensure compatibility for the gradual upgrade of existing Wiegand-based access control systems to OSDP-based systems.

However, Wiegand typically uses six signal lines to connect the controller and the reader, whereas OSDP uses only four. When both protocols are used concurrently, they must share the same input/output signal lines. As a result, in an OSDP mode, two signal lines become unused and thus wasted.

In light of this, the inventors of the present disclosure have devised a method and apparatus capable of efficiently utilizing the signal lines in both the Wiegand mode and the OSDP mode.

Accordingly, an object of the present disclosure is to provide a method and apparatus for controlling signals in an access control system that combines the advantages of both the Wiegand-based communication protocol and the OSDP-based communication protocol to enhance security and scalability. In particular, by converting unused output ports into input ports in the OSDP mode, the present disclosure improves signal line utilization, thereby providing additional input functionality to the user without increasing hardware costs.

It should be understood that the technical problems described above are provided for illustrative purposes only and do not limit the scope of the present disclosure. Other objects and advantages of the present disclosure will be readily understood by those skilled in the art from the following detailed description.

According to one or more embodiments, a method for controlling signals in an access control system according to one or more embodiments of the present disclosure is provided. The method may include: identifying a communication protocol used by a reader upon receiving identification information from the reader disposed in a designated area, setting an operation mode to one of a plurality of modes based on the communication protocol of the reader; determining whether to convert at least some of signal lines connected as output ports among a plurality of signal lines into input ports based on the set operation mode and setting a switching direction of a control logic circuit; and inputting or outputting data required for a user's access verification procedure to the designated area through a path formed by the set switching direction. The plurality of modes may include a Wiegand mode or an Open Supervised Device Protocol (OSDP) mode

According to one or more embodiments, the determining whether to convert the at least some of the signal lines into the input ports may include controlling the control logic circuit to convert the at least some of the signal lines into the input ports based on the set operation mode being the OSDP mode.

According to one or more embodiments, inputting or outputting the data may include outputting the data by using all the signal lines as the output ports through a path formed by maintaining the switching direction of the control logic circuit in a default direction based on the set operation mode being the Wiegand mode.

According to one or more embodiments, the inputting or outputting the data may include: receiving the data through a path formed by converting the at least some of the signal lines into the input ports by changing the switching direction of the control logic circuit; and outputting the data by using remaining output ports through a path based on the set operation mode being the OSDP mode.

According to one or more embodiments, the method may further include restoring the set switching direction to a default direction based on a predetermined time or a predetermined condition, based on the at least some of the signal lines having been converted into the input ports.

According to one or more embodiments, at least some of the output ports may be configured to provide notifications through a notification device such as at least one of a buzzer and a light-emitting module, not being limited thereto.

According to one or more embodiments, the data input through the converted input ports may include at least one of authentication history information of the user, status information of at least one of the reader and an access restriction device connected to the reader, and environmental information surrounding the designated area.

According to one or more embodiments, the control logic circuit may be implemented based on a microcontroller unit (MCU), and the switching direction of the control logic circuit may be automatically changed in response to a control signal generated based on the communication protocol.

According to one or more embodiments, a signal control apparatus in an access control system according to one or more embodiments of the present disclosure is provided. The apparatus may include: a communication interface; a memory; and a processor operably connected to the communication interface and the memory, in which the processor may be configured to identify a communication protocol used by a reader upon receiving identification information from the reader disposed in a designated area; set an operation mode to one of a plurality of modes based on the communication protocol of the reader; determine whether to convert at least some of signal lines connected as output ports among a plurality of signal lines into input ports based on the set operation mode, and set a switching direction of a control logic circuit; and input or output data required for a user's access verification procedure to the designated area through a path formed by the set switching direction.

According to one or more embodiments, the processor may be configured to, when determining whether to convert the at least some of the signal lines into the input ports, control the control logic circuit to perform the conversion based on the set operation mode being the OSDP mode, such that the at least some of the signal lines are converted into the input ports.

Other specific details of example embodiments are included in the following detailed description and the accompanying drawings.

According to the present disclosure, both Wiegand-based and OSDP-based communication protocols are utilized, allowing the advantages of both protocols to be combined, thereby satisfying requirements for security and scalability. In particular, by converting unused output ports into input ports during the OSDP mode, the utilization of signal lines can be improved, enabling the provision of additional input functionality to the user without increasing hardware costs.

The effects of the present disclosure are not limited to the examples described herein, and various other advantages are also encompassed within the scope of the present disclosure.

The effects of the present disclosure are not limited to the effects described herein, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic diagram illustrating an access control system according to one or more embodiments of the present disclosure;

FIG. 2 is a block diagram illustrating configurations of a signal control apparatus for controlling signals for access control according to one or more embodiments of the present disclosure;

FIG. 3 is a block diagram illustrating configurations of an administrator terminal using access control services provided by a central server according to one or more embodiments of the present disclosure;

FIG. 4 is a diagram illustrating an I/O path configuration of a control logic circuit within a signal control apparatus in an access control system according to one or more embodiments of the present disclosure;

FIG. 5 is a diagram illustrating a specific example of I/O paths formed depending on switching direction setting of a control logic circuit in a signal control apparatus in an access control system according to one or more embodiments of the present disclosure;

FIG. 6 is a flowchart schematically illustrating a signal control method in an access control system according to one or more embodiments of the present disclosure;

FIGS. 7A and 7B are diagrams illustrating examples of signal pin usage in a Wiegand mode and in an OSDP mode, respectively, according to one or more embodiments of the present disclosure;

FIG. 8 is a diagram illustrating an example of a user interface screen implemented to allow a user to visually check an operation status of a signal control apparatus in an access control system according to one or more embodiments of the present disclosure; and

FIG. 9 is a diagram illustrating a circuit structure in which I/O directions of FLEX ports are dynamically switched in response to control signals during operation in the OSDP mode in an access control system, according to one or more embodiments of the present disclosure.

### DETAILED DESCRIPTION OF EMBODIMENTS

When the relation of a time sequential order is described using the terms such as “after”, “continuously to”, “next to”, and “before”, the order may not be continuous unless the terms are used with the term “immediately” or “directly”.

In describing components of the exemplary embodiment of the present disclosure, terminologies such as first, second, A, B, (a), (b), and the like may be used. These terminologies are used to distinguish a component from the other component, but a nature, an order, or the number of the components is not limited by the terminology. When a component is “linked”, “coupled”, or “connected” to another component, the component may be directly linked or connected to the other component. However, unless specifically stated otherwise, it should be understood that a third component may be interposed between the components which may be indirectly linked or connected.

It should be understood that “at least one” includes all combinations of one or more of associated components. For example, “at least one of first, second, and third components” and “at least one of first, second, or third” mean that not only a first, second, or third component, but also all combinations of two or more of first, second, and third components are included. As used herein, the term “and/or” includes any and all combinations of one or more of the associated listed items.

In the present specification, a “display apparatus” may include a display apparatus which includes a display panel and a driver for driving the display panel, in a narrow sense, such as a liquid crystal module (LCM), an organic light emitting diode (OLED) module, and a quantum dot (QD) module. Further, the “display apparatus” may further include a set electronic apparatus or a set apparatus (or a set device) which is a complete product or a final product including an LCM, an OLED module, a QD module, etc., such as a notebook computer, a television, or a computer monitor, an automotive display apparatus or equipment display apparatus including another type of vehicle and a mobile electronic apparatus including a smart phone or an electronic pad.

Accordingly, the display apparatus of the present disclosure may include not only a display apparatus itself in a narrow sense such as an LCM, an OLED module, a QD module, etc., but also an applied product or a set apparatus which is a final consumer device including the LCD, the OLED module, the QD module, etc.

Further, in some cases, the LCM, the OLED module, or the QD module which is configured by a display panel and a driver may be represented as “a display apparatus” in a narrow sense and an electronic device as a complete product including the LCM, the OLED module, and the QD module may be represented as a “set apparatus”. For example, the display apparatus in the narrow sense includes a liquid crystal (LCD) display panel, an OLED display panel, or a quantum dot display panel and a source PCB which is a controller for driving the display panel. In contrast, the set apparatus may be a concept further including a set PCB which is a set controller which is electrically connected to the source PCB to control the entire set apparatus.

As a display panel used in the exemplary embodiment of the present disclosure, any type of display panel such as a liquid crystal display panel, an OLED display panel, a QD display panel, and an electroluminescent display panel may be used. The display panel of the present exemplary embodiment is not limited to a specific display panel in which a bezel is bent with a flexible substrate for the OLED display panel and a back plate support structure therebelow. Further, a display panel used for the display apparatus according to the exemplary embodiment of the present disclosure is not limited to a shape or a size of the display panel.

For example, when the display panel is an OLED display panel, the display panel may include a plurality of gate lines, data lines, and pixels formed at intersecting areas of the gate lines and/or data lines. Further, the display panel may be configured to include an array including a thin film transistor which is an element to selectively apply a voltage to each pixel, a light emitting diode layer on the array, an encapsulation substrate or an encapsulation layer, and the like disposed on the array so as to cover the light emitting diode layer. The encapsulation layer may protect the thin film transistor the light emitting diode layer, and the like from external impacts and may suppress the permeation of moisture or oxygen into the light emitting diode layer. Further, a layer formed on the array may include an inorganic light emitting layer, for example, a nano-sized material layer quantum dots, or the like.

The features of various exemplary embodiments of the present disclosure can be partially or entirely coupled to or combined with each other and can be interlocked and operated in technically various ways, and the exemplary embodiments can be carried out independently of or in association with each other.

Hereinafter, the exemplary embodiments of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

The advantages and features of the present disclosure, and the manner in which they are achieved, will become apparent with reference to the embodiments described in detail below in conjunction with the accompanying drawings. However, the present disclosure is not limited to the embodiments set forth herein and may be implemented in various other forms. These embodiments are merely provided to ensure that the present disclosure is thorough and complete, and to fully convey the scope of the invention to those skilled in the art. The present disclosure is defined only by the scope of the claims. In the drawings, reference numerals may be used to denote like or similar elements.

In this document, expressions such as “has,” “may have,” “includes,” or “may include” indicate the presence of a stated feature (e.g., numerical value, function, operation, or components such as parts), but do not preclude the presence of additional features.

In this document, the expression “configured to” (or “set to”) may, depending on the context, be used interchangeably with expressions such as “suitable for,” “having the capacity to,” “designed to,” “adapted to,” “made to,” or “capable of.” The term “configured to” does not necessarily imply that a device is “specifically designed to” perform the stated function in hardware. Rather, in some contexts, an expression like “a device configured to perform ~” may refer to a device that is “capable of” performing such a function when used together with other devices or components. For example, the phrase “a processor configured to (or set to) perform A, B, and C” may refer to a dedicated processor (e.g., an embedded processor) designed to perform such operations, or a general-purpose processor (e.g., a CPU, MCU, or application processor) capable of performing those operations by executing one or more software programs stored in a memory device.

The terms used in this document are provided merely to describe particular embodiments and are not intended to limit the scope of other embodiments. Unless clearly stated otherwise in the context, the singular expressions may also include the plural forms. Terms used herein including technical or scientific terms may have the same meanings as commonly understood by those of ordinary skill in the art to which the present disclosure pertains. Terms used in this document that are defined in general dictionaries may be interpreted as having the same or similar meanings as understood in the context of the relevant technical field, and are not to be interpreted in an idealized or overly formal sense unless expressly defined otherwise herein. In some cases, even terms that are defined in this document should not be interpreted as excluding the described embodiments.

The respective features of various embodiments of the present disclosure may be combined or integrated in whole or in part, and as will be readily understood by those skilled in the art, various technical interoperations and operations are possible. Each embodiment may be implemented independently of, or in association with, one another.

For clarity of interpretation of the present disclosure, the terms used herein will be defined below.

A device referred to hereinafter as a “central server” in the present disclosure may refer to a physically independent server, but is not limited thereto. It is intended to encompass various implementations including a virtual machine, a module, program, or a docker running on a virtual or physical machine.

Hereinafter, example embodiments of the present disclosure will be described in detail with reference to the accompanying drawings.

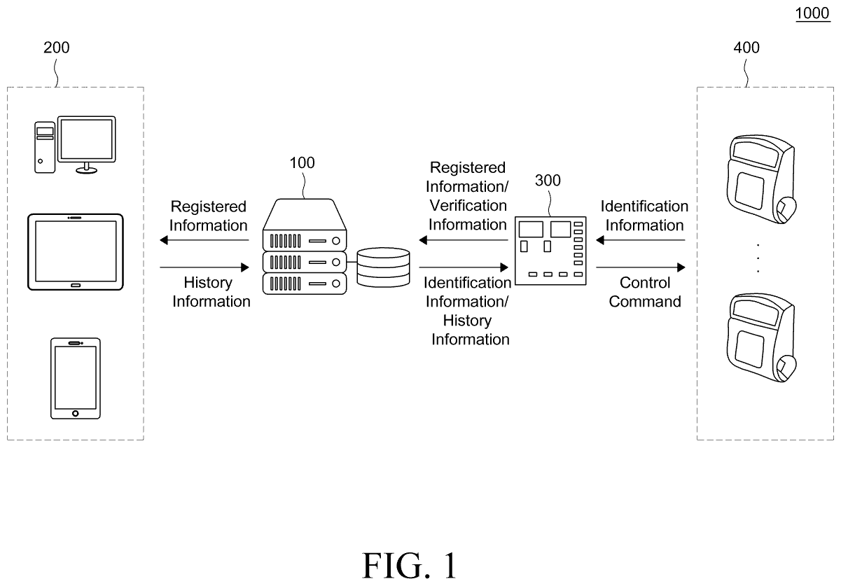

FIG. 1 is a schematic diagram illustrating an access control system according to one or more embodiments of the present disclosure.

Referring to FIG. 1, an access control system 1000 according to one or more embodiments of the present disclosure may include a central server 100, an administrator terminal 200, a signal control apparatus 300, and a reader 400. The access control system 1000 determines whether to open or close an access restriction device of a gate configured to open and close, based on identification information of a user attempting to access a designated area, that is, whether to permit or deny the user's entry. In addition, the access control system 1000 may provide a notification corresponding to a verification result (i.e., whether entry is granted or denied) about the user via a buzzer and/or a light-emitting module (e.g., at least one light-emitting device).

First, the central server 100 may correspond to a web server, and refers to a device for performing access control or access monitoring of a designated area in real time in the access control system 1000 according to one or more embodiments of the present disclosure.

The central server 100 may be connected to the administrator terminal 200, the signal control apparatus 300, and/or the reader 400 to collect or receive all information and data related to the access control service. To this end, the central server may be linked to a separate API (application programming interface). The API refers to a collection of screen configurations, various functions, and other resources that enable application developers to easily develop programs running on an operating system.

When identification information collected based on an identification means via the reader 400 is received from the signal control apparatus 300, the central server 100 may store the information in a database or perform verification of the user attempting to access the designated area using registered information. Accordingly, the central server 100 may determine whether to open or close an access restriction device of the gate, and transmit the result to the signal control apparatus 300. Here, the registered information may include at least one of an identification number of each area monitored by the central server 100, an identification number for each of designated space, an identification number for each reader installed in each designated area or space, specifications of each reader, an identification number corresponding to a visitor badge or access card of each user, or biometric data of each user such as fingerprints, irises, facial data, or vein patterns. The registered information may be updated via the administrator terminal 200 either periodically or whenever changes occur, and may also be transmitted to the signal control apparatus 300 for update.

That is, the central server 100 may simply serve to store and manage various types of information and data received from the administrator terminal 200 and/or the signal control apparatus 300, and act as a relay to exchange such information/data between the administrator terminal 200 and the signal control apparatus 300. Alternatively, the central server 100 may determine whether to permit or deny the user's access by verifying the received information or data from the signal control apparatus 300 and accordingly decide whether to open or close the access restriction device of the gate.

In the former case, the signal control apparatus 300 may directly control whether to open or close the access restriction device based on the registered information received from the central server 100.

To this end, the central server 100 may be configured to pre-collect and store, in a database, registered information including information received from the administrator terminal 200 for verifying at least one user authorized to access a designated area. In addition, the central server 100 may be configured to pre-receive and store, in a database, administrator information received from the administrator terminal 200. The administrator information includes information regarding an administrator corresponding to a designated area and/or information regarding an administrator corresponding to each space within the designated area. The central server 100 may also be configured to transmit the registered information and/or the administrator information to the signal control apparatus 300 for storage.

In this case, at least one space may be formed within the designated area, and gates may be installed not only for entry into and exit from the designated area, but also for entry into and exit from each space. In such cases, access restriction devices may also be installed at each gate and may be operated and/or driven independently. That is, the central server 100 may receive identification information from the signal control apparatus 300 not only when a user enters or exits the designated area, but also whenever the user enters or exits each space.

Furthermore, the central server 100 may transmit the registered information and/or administrator information to the signal control apparatus 300 for update either at predetermined intervals or whenever there is a change in the registered information and/or the administrator information.

In addition, the central server 100 may be configured to collect history information including access histories of users received from the signal control apparatus 300 and store the information in a database, and to provide such information to an administrator via the administrator terminal 200 in response to a request of the administrator. The history information may be received from the signal control apparatus 300 upon each occurrence of an access request or permission, or may be accumulated over a predetermined period and then received from the signal control apparatus 300 at predetermined intervals. The access history may represent only access history (actual access records) in which access to a designated space was permitted and completed, or may additionally include attempted access history (attempted access records) regardless of whether access was granted, and the scope of the information to be included may be set by the administrator.

Meanwhile, the administrator terminal 200 is a general term for a terminal possessed by an administrator (or operator) who utilizes the access control service provided by the central server 100. There may be at least one such terminal, and the number and type thereof are not limited.

When a plurality of administrator terminals 200 are present, the central server 100 may selectively transmit the history information to only at least one administrator terminal 200 corresponding to a designated area and/or a designated space, among the plurality of administrator terminals 200.

For example, since different administrators may be responsible for different spaces within a designated area, the central server 100 may identify at least one administrator corresponding to the designated area and/or each space within the designated area, and then transmit the history information to the respective administrator terminal 200 of the at least one identified administrator.

Meanwhile, the administrator terminal 200 may be any type of device on which each administrator can install and execute various application programs (i.e., applications). Examples of the administrator terminal 200 include computers, UMPCs (ultra mobile PCs), workstations, netbooks, PDAs (personal digital assistants), portable computers, web tablets, wireless phones, mobile phones, smartphones, pads, smart watches, wearable devices, e-books, PMPs (portable multimedia players), handheld game consoles, navigation devices, black boxes, or digital cameras, as well as other mobile communication terminals, but are not limited to the aforementioned examples.

Meanwhile, the signal control apparatus 300 is connected to the reader 400 (which may be a specific one among at least one reader) and the central server 100. When identification information for a specific user is collected via the reader 400, the signal control apparatus 300 may transmit the identification information to the central server 100 and receive verification information in response. Accordingly, the signal control apparatus 300 may transmit a control command (e.g., a lock or unlock command) to the reader 400 to open or close the access restriction device based on the verification information.

In addition, the signal control apparatus 300 accumulates and stores history information including actual access histories or attempted access histories of users for a designated area or for each space within the designated area. Accordingly, when a request for the history information is received from an administrator via the administrator terminal 200, the signal control apparatus 300 may transmit the history information to the administrator terminal 200 so that the administrator can review it.

In this case, the signal control apparatus 300 and the reader 400 may perform communication for access control by utilizing a combination of a first protocol based on Wiegand and a second protocol based on Open Supervised Device Protocol (OSDP).

In addition, when identification information for a user is received from a specific reader 400 among at least one connected reader, the signal control apparatus 300 may set an operation mode to a Wiegand mode or an OSDP mode according to the protocol, i.e., the communication method, of the specific reader 400, and input or output data required for the access verification procedure for the designated area of the user.

For example, in the Wiegand mode, all six signal lines may be used as output ports, whereas in the OSDP mode, two of the six signal lines may be converted and used as input ports. In this case, the two signal lines may be originally connected to output ports for notifications, and at least some of these output ports for notifications may be converted into input ports.

Additionally, the reader 400 may be installed at at least one gate within a designated area to scan (or sense) an identification means, and transmit the identification information obtained through the scan to the signal control apparatus 300.

The reader 400 may also be linked or connected to an access restriction device installed at each gate. In this case, the reader 400 may receive a control command (e.g., a lock or unlock command) from the signal control apparatus 300 to open or close the access restriction device, and control the access restriction device according to the received control command.

Through such access control system 1000, it becomes possible to meet both security and scalability requirements by utilizing both a protocol based on the Wiegand method and a protocol based on the OSDP method, thereby combining the advantages of both protocols.

Meanwhile, although only one signal control apparatus 300 is illustrated in FIG. 1, the signal control apparatus 300 may be provided for each designated area and/or each specific space. In such a case, an integrated control device for managing a plurality of signal control apparatus 300 may be further provided.

Hereinafter, the present disclosure will be described in more detail based on the embodiments described above.

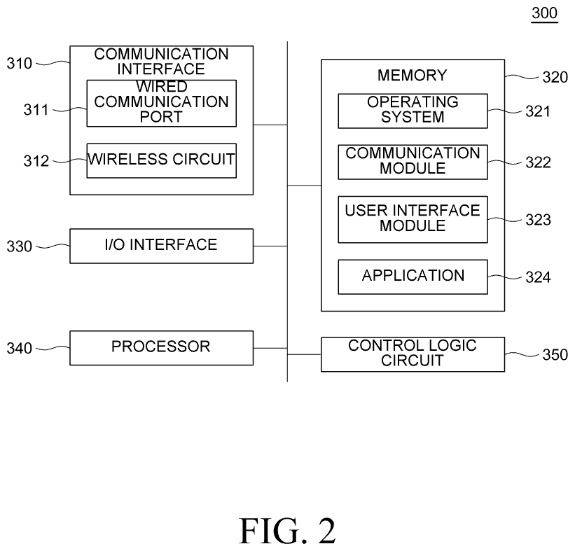

FIG. 2 is a block diagram illustrating a configuration of a signal control apparatus for controlling signals for access control according to one or more embodiments of the present disclosure.

Referring to FIG. 2, a signal control apparatus 300 may include a communication interface 310, a memory 320, an input/output (I/O) interface 330, a processor 340, and a control logic circuit 350. Each of these components may communicate with one another via one or more communication buses or signal lines. The signal control apparatus 300 of FIG. 2 may be or correspond to the signal control apparatus 300 shown in FIG. 1.

The communication interface 310 may be connected to the central server 100, the reader 400, and other devices via a wired or wireless communication network, and may transmit and receive data accordingly.

Meanwhile, the communication interface 310, which enables transmission and reception of data, may include a wired communication port 311 and a wireless circuit 312. The wired communication port 311 may include one or more wired interfaces, such as Ethernet, universal serial bus (USB), or FireWire. The wired communication port 311 may be configured to include at least one input port and at least one output port. In addition, the wireless circuit 312 may transmit and receive data with external devices through radio frequency (RF) signals or optical signals. Moreover, the wireless communication may use at least one of a plurality of communication standards, protocols, and technologies, such as GSM, EDGE, CDMA, TDMA, Bluetooth, Wi-Fi, VoIP, Wi-MAX, or any other suitable communication protocol.

The memory 320 may store at least one process (algorithm) for access control or data for a program that reproduces the process. In addition, the memory 320 may further store other processes for performing various operations, without being limited thereto.

Meanwhile, the memory 320 may also store various types of data used by the central server 100, and, if necessary, may also build and store at least one pre-trained artificial intelligence (AI) model.

In various embodiments, the memory 320 may include a volatile or non-volatile storage medium capable of storing various types of data, commands, and information. For example, the memory 320 may include at least one type of storage medium such as a flash memory type, hard disk type, multimedia card micro type, card-type memory (e.g., SD or XD memory), RAM, SRAM, ROM, EEPROM, PROM, network storage, cloud storage, or a blockchain database.

In various embodiments, the memory 320 may store at least one component among an operating system 321, a communication module 322, a user interface module 323, and one or more applications 324.

The operating system 321 (e.g., an embedded operating system such as LINUX, UNIX, MAC OS, WINDOWS, or VxWorks) may include various software components and drivers for controlling and managing general system operations such as memory management, storage device control, and power management. It may also support communication among various hardware, firmware, and software components.

The communication module 322 may support communication with other devices through the communication interface 310. The communication module 322 may include various software components for processing data received via the wired communication port 311 or the wireless circuit 312 of the communication interface 310.

The user interface module 323 may receive a user (e.g., an entrant or an administrator) request or input from a keyboard, touch screen, microphone, or the like through the I/O interface 330, and may provide a user interface on a display.

The application 324 may include programs or modules configured to be executed by one or more processors 340.

The I/O interface 330 may connect at least one of input/output devices of the central server 100, such as a display, keyboard, touch screen, or microphone, to the user interface module 323. The I/O interface 330, together with the user interface module 323, may receive user inputs (e.g., voice input, keyboard input, touch input, etc.) and process commands based on the received user inputs.

The processor 340 may be connected to the communication interface 310, the memory 320, and the I/O interface 330, and may control overall operations of the signal control apparatus 300. The processor 340 may execute various commands through an application or program stored in the memory 320.

The processor 340 may correspond to a computing unit such as a central processing unit (CPU), a microcontroller unit (MCU), or an application processor (AP). In addition, the processor 340 may also be implemented in the form of an integrated chip (IC), such as a system on chip (SoC) in which various computing units are integrated. Alternatively or additionally, the processor 340 may include a module for computing an artificial neural network model, such as a neural processing unit (NPU).

For example, when identification information is received via a reader 400 installed in a designated area, the processor 340 may transmit the identification information to the central server 100, receive verification information in response thereto, and verify the access authority of a specific user based on the verification information. Accordingly, the processor 340 may transmit a control command to the reader 400 to lock or unlock an access restriction device.

Here, the identification information refers to information collected when a user presents an identification means to the reader 400, and may include at least one of an identification number of the designated area, an identification number of the reader 400, an identification number corresponding to the user's visitor badge or access card, or biometric data of the user (e.g., fingerprint, iris, facial data, or vein patterns). The identification means may be a card, such as a visitor badge or access card carried by the user, which may be a physical card or a mobile card. Additionally, the identification means may include biometric data of the user. The reader 400 may include at least one of corresponding sensors such as a touch sensor, a camera, a radio frequency identification (RFID) reader, etc., not being limited thereto.

Meanwhile, when identification information of a user is received from a reader 400 (which may be a specific one among at least one reader) installed in a designated area, the processor 340 may be configured to identify a communication protocol used by the reader 400, set an operation mode to either a Wiegand mode or an OSDP mode based on the identified communication protocol, determine whether to convert at least some of signal lines connected as output ports among a plurality of signal lines into input ports according to the set operation mode, set a switching direction of the control logic circuit 350 accordingly, and then input or output data for an access verification procedure to the designated area through a path formed by the set switching direction. Here, at least some of the entire output ports may be allocated to provide notifications via at least one of a buzzer and a light-emitting module. Thus, the reader 400 may include one or more notification devices such as a buzzer, a light-emitting module, a display device, and a speaker, not being limited thereto. The light-emitting module may include at least one light-emitting device, for example, a light emitting diode (LED) device, not being limited thereto.

In this case, the processor 340 may be further configured to control the control logic circuit 350 to convert at least some of the plurality of signal lines into input ports only when the set operation mode is the OSDP mode, when determining whether to convert at least some of the plurality of signal lines into input ports.

In other words, since output ports provided for notifications are not used in the OSDP mode, the processor 340 is configured to convert such output ports into input ports. In this case, a plurality of output ports may be provided for notification purposes, and all or only some of the plurality of output ports may be converted into input ports. The number of input ports converted is not limited.

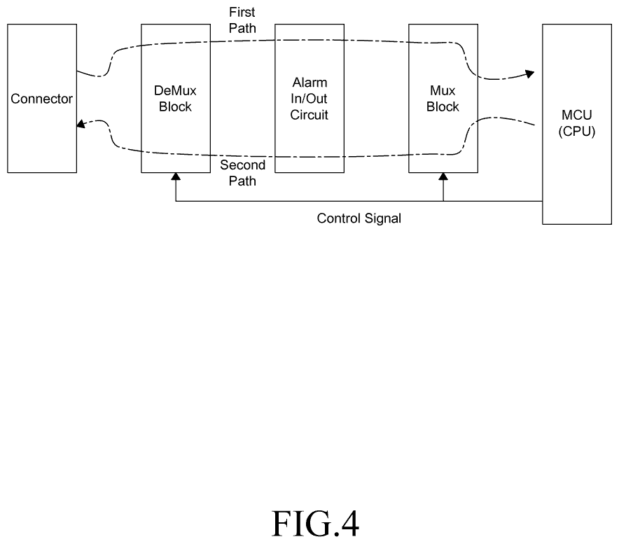

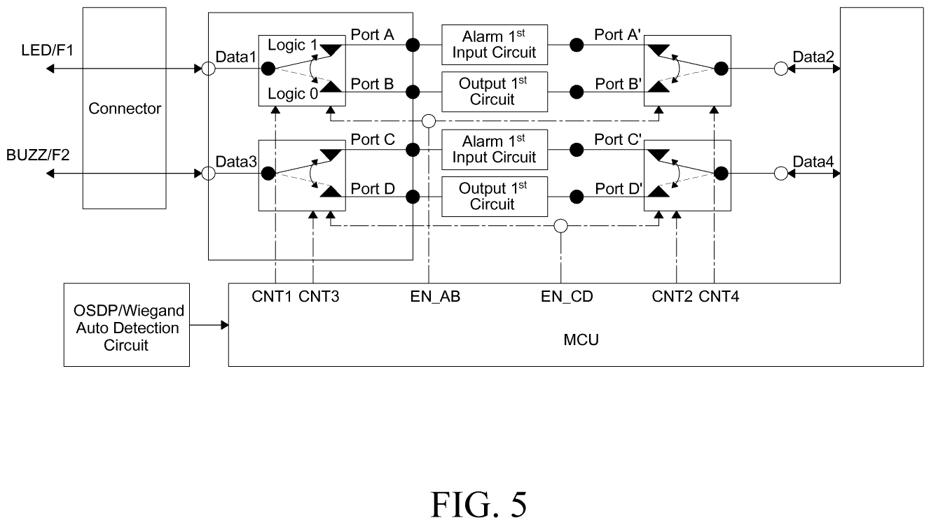

For example, when the set operation mode is the Wiegand mode, the processor 340 may be configured to output data by using all of the plurality of signal lines as output ports through a second path formed by maintaining the switching direction of the control logic circuit 350 in a default direction. Furthermore, when the set operation mode is the OSDP mode, the processor 340 may be configured to change the switching direction of the control logic circuit 350 to receive data through a first path formed by converting at least some of the signal lines connected as output ports among the plurality of signal lines into input ports, and to output data through remaining output ports via the second path. The control logic circuit 350 will be further described in reference to FIGS. 4 and 5. The control logic circuit 350 may be implemented in the processor 340, according to one or more other embodiments.

Meanwhile, the processor 340 may be further configured to restore the set switching direction to a default direction based on a predetermined time or a predetermined condition, when at least some of the signal lines connected as output ports among the plurality of signal lines are converted into input ports. The predetermined condition may include when a control command for the user corresponding to the identification information is transmitted to the reader, when additional identification information is received, or when it is confirmed that the reader transmitting the additionally received identification information uses a Wiegand-based communication protocol. In this case, if the reader that transmitted the additionally received identification information is the same as the reader that transmitted the previous identification information, the processor 340 may be configured to skip the operation of confirming the communication protocol.

For example, in the Wiegand mode, unidirectional communication is performed between the signal control apparatus 300 and the reader 400, and the processor 340 outputs data to the reader 400 through all output ports. The data output to the reader 400 may include at least one of a control command for locking or unlocking the access restriction device, a buzzer control signal, or an LED control signal. For example, in response to the buzzer control signal, a warning sound in a preset pattern may be output respectively when access is granted, when access is denied, or when an abnormal approach is detected. In addition, in response to the LED control signal, a green LED may be turned on in the light-emitting module of the reader 400 when access is granted, and a red LED may be turned on in the light-emitting module of the reader 400 when access is denied. Even in the case where the LED is turned on, a preset lighting pattern may also be applied.

Meanwhile, in the OSDP mode, bidirectional communication is performed between the signal control apparatus 300 and the reader 400. Accordingly, the processor 340 may receive data from the reader 400 through input ports that are converted from all output ports, and may output data to the reader 400 through the remaining output ports that have not been converted into input ports. For example, through the converted input ports, at least one of status information of the reader 400 or an access restriction device connected to the reader 400, or surrounding environmental information of a designated area may be received from the reader 400. Additionally, through the remaining output ports, data such as door open/close status information from a door sensor installed at a gate, or emergency access request data from an emergency button may be received. Furthermore, through the remaining output ports, simple control commands or control signals for controlling at least one of the reader 400 or an access restriction device connected to the reader 400 may be transmitted. That is, in the OSDP mode, the unused output ports may be utilized to provide additional input functionality.

When operated in the OSDP mode, data may be transmitted and received between the signal control apparatus 300 and the reader 400 using a data packet transmission method over a dedicated data line (RS-485 communication line) based on the RS-485 protocol. However, more diverse types of data may also be output or input via the output ports and the input ports formed by converting some of the output ports. In this case, through the data packet transmission method, a verification result packet indicating the verification result for the user's access rights, a command packet for locking or unlocking the access restriction device, a device setting packet for changing the settings of a buzzer and/or LED, a status information packet regarding the status and errors of the reader 400 or the access restriction device connected to the reader 400, and a status report packet for reporting the status of various sensors or the like may be transmitted and received.

Meanwhile, although not illustrated in FIG. 2, all information and data may be transmitted to the central server 100 via TCP/IP.

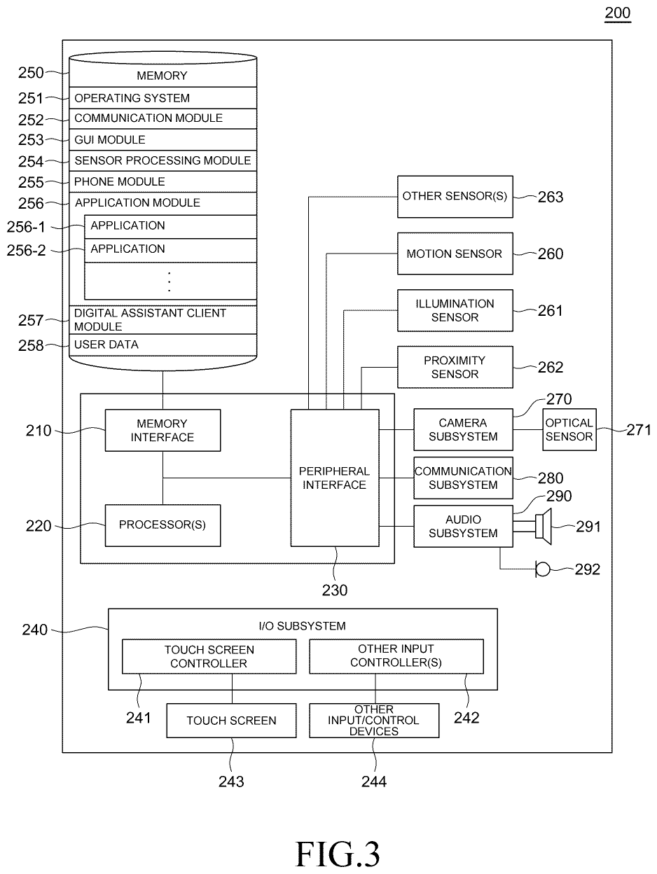

Hereinafter, with reference to FIGS. 3 to 9, the detailed operations of the processor 340 will be described.

FIG. 3 is a block diagram illustrating configurations of an administrator terminal using access control services provided by a central server according to one or more embodiments of the present disclosure.

Referring to FIG. 3, an administrator terminal 200 may include a memory interface 210, one or more processors 220, and a peripheral interface 230. Various components within the administrator terminal 200 may be connected via one or more communication buses or signal lines. The administrator terminal 200 may be or correspond to the administrator terminal 200 shown in FIG. 1.

The memory interface 210 is connected to a memory 250 and may deliver various types of data to the processor 220. The memory 250 may include at least one type of storage medium such as flash memory type, hard disk type, micro-type multimedia card type, card-type memory (e.g., SD or XD memory), RAM, SRAM, ROM, EEPROM, PROM, network storage, cloud storage, or blockchain database.

In various embodiments, the memory 250 may store a web/app application or program that is configured to provide an access control service. The memory 250 may also store various types of information about users and may further store various types of information acquired through the application or program.

In various embodiments, the memory 250 may store at least one of an operating system 251, a communication module 252, a graphical user interface (GUI) module 253, a sensor processing module 254, a telephone module 255, and an application module 256. For example, the operating system 251 may include instructions for processing basic system services and for executing hardware-level operations. The communication module 252 may enable communication with at least one of one or more other devices, computers, and servers. The GUI module 253 may be configured to process graphical user interfaces. The sensor processing module 254 may process sensor-related functions (e.g., processing voice input received through one or more microphones 292). The telephone module 255 may handle telephone-related functions. The application module 256 may perform various functions of user applications, such as electronic messaging, web browsing, media processing, navigation, imaging, and other processing functions. Additionally, the administrator terminal 200 may store, in the memory 250, one or more software applications 256-1, 256-2 associated with a specific type of service (e.g., service applications).

In various embodiments, the memory 250 may store a digital assistant client module 257 (hereinafter referred to as “DA client module”) and, accordingly, store instructions for performing client-side functions of a digital assistant, as well as various types of user data 258 (e.g., user-customized vocabulary data, preference data, and other data such as the user's electronic address book).

The DA client module 257 may acquire user input in the form of voice, text, touch, and/or gestures through various user interfaces (e.g., I/O subsystem 240) provided in the administrator terminal 200.

In addition, the DA client module 257 may output data in audiovisual or tactile formats. For example, the DA client module 257 may output data in at least one or more combinations of voice, sound, notifications, text messages, menus, graphics, videos, animations, and vibrations. Furthermore, the DA client module 257 may communicate with a digital assistant server via a communication subsystem 280.

In various embodiments, the DA client module 257 may collect additional information regarding a surrounding environment of the administrator terminal 200 from various sensors, subsystems, and peripheral devices in order to construct context associated with a user input. For example, the DA client module 257 may provide context information together with the user input to a digital assistant server to assist in inferring the user's intent. The context information that may accompany the user input may include sensor information, such as lighting, ambient noise, ambient temperature, and images or videos of the surrounding environment. In another example, the context information may include the physical state of the administrator terminal 200 (e.g., device orientation, device location, device temperature, power level, velocity, acceleration, motion patterns, and cellular signal strength). In yet another example, the context information may include information related to a software state of the administrator terminal 200 (e.g., running processes in the administrator terminal 200, installed programs, past and current network activity, background services, error logs, and resource usage).

In various embodiments, the memory 250 may include added or deleted instructions. Furthermore, the administrator terminal 200 may include additional components other than those illustrated in FIG. 3 or may exclude some of the illustrated components.

The processor 220 may control overall operations of the administrator terminal 200 and may execute various commands for using the access control services provided by the central server 100 by running applications or programs stored in the memory 250.

The processor 220 may correspond to a computing device such as a central processing unit (CPU), a micro controller unit (MCU), or an application processor (AP). Additionally or alternatively, the processor 220 may be implemented in the form of an integrated chip (IC), such as a system on chip (SoC) that integrates various computing devices for performing machine learning, such as a neural processing unit (NPU).

In various embodiments, the processor 220 may display various types of information and/or data for route guidance based on the platform via a user interface screen.

The peripheral interface 230 may be connected to various sensors, subsystems, and peripheral devices and may provide data so that the administrator terminal 200 can perform various functions. It should be understood that the performance of such functions by the administrator terminal 200 may be carried out by the processor 220.

The peripheral interface 230 may acquire data from a motion sensor 260, an illumination sensor (light sensor) 261, and a proximity sensor 262, and based on this data, the administrator terminal 200 may perform orientation detection, light sensing, and proximity sensing functions. In another example, the peripheral interface 230 may acquire data from other sensors 263 (e.g., a positioning system-GPS receiver, a temperature sensor, or a biometric sensor), and based on this data, the administrator terminal 200 may perform functions associated with such other sensors 263.

In various embodiments, the administrator terminal 200 may include a camera subsystem 270 connected to the peripheral interface 230 and an optical sensor 271 associated therewith, such that the administrator terminal 200 may perform various imaging functions including taking photographs and recording video clips.

In various embodiments, the administrator terminal 200 may include a communication subsystem 280 connected to the peripheral interface 230. The communication subsystem 280 may include one or more wired or wireless networks, and may further include various communication ports, radio frequency transceivers, and optical transceivers.

In various embodiments, the administrator terminal 200 may include an audio subsystem 290 connected to the peripheral interface 230. The audio subsystem 290 may include one or more speakers 291 and one or more microphones 292. Accordingly, the administrator terminal 200 may support voice-activated functions, such as voice recognition, voice reproduction, digital recording, and telephony functions.

In various embodiments, the administrator terminal 200 may include an I/O subsystem 240 connected to the peripheral interface 230. For example, the I/O subsystem 240 may control a touch screen 243 included in the administrator terminal 200 through a touch screen controller 241.

For instance, the touch screen controller 241 may detect a user's touch and movement, or termination thereof, using any one of a plurality of touch sensing technologies, such as capacitive, resistive, infrared, surface acoustic wave (SAW), or proximity sensor arrays. In another example, the I/O subsystem 240 may control other input/control devices 244 included in the administrator terminal 200 through other input controller(s) 242. For instance, the other input controller(s) 242 may control one or more pointer devices, such as buttons, rocker switches, thumb-wheels, infrared ports, USB ports, or styluses.

FIG. 4 is a diagram illustrating an I/O path configuration of a control logic circuit within a signal control apparatus in an access control system according to one or more embodiments of the present disclosure. The control logic circuit of FIG. 4 may be or correspond to the control logic circuit 350 provided in the signal control apparatus 300 of FIG. 2.

Referring to FIG. 4, the control logic circuit includes a path connected to a connector, a demultiplexer (DeMux block), an alarm input/output circuit (alarm in/out circuit), a multiplexer (Mux block), and an MCU (control logic). Depending on a control signal, either a first path or a second path is activated.

First, the first path (Path 1)) represents an input/output path used in the OSDP mode, where at least some of the FLEX ports are converted into input ports. In this case, signals received from an external source are sequentially transmitted through the connector, the DeMux block, the alarm input circuit (alarm in circuit), and the Mux block, and then input to the MCU. That is, the signal flow direction follows the order of the connector, the DeMux block, the alarm in circuit, the Mux block and the MCU, representing the input direction. This first path indicates that dedicated output ports such as LED/FLEX1 or BUZZ/FLEX2 may be reconfigured for input functions in the OSDP mode, and used to receive inputs from peripheral devices or sensors.

Meanwhile, a second path (Path 2) serves as a dedicated output path that is primarily used in the Wiegand mode. In this configuration, an output signal generated by the MCU is delivered externally via the Mux block, the alarm input/output circuit (output circuit), the DeMux block, and the connector. That is, the signal flow direction follows the order of MCU, Mux block, output circuit, DeMux block, and connector, representing the output direction. The second path is used to transmit signals to a Wiegand communication-based reader, buzzer, or LED control device.

In this case, the MCU generates appropriate control signals (e.g., CNT1 to CNT4, EN_AB, etc.) according to the communication protocol (Wiegand or OSDP) and may dynamically switch the input/output direction of each signal line via the Mux block and the DeMux block. In the OSDP mode, since bidirectional communication is possible, unused output ports can be converted into input ports to improve efficiency. In contrast, in the Wiegand mode, all ports are used as unidirectional outputs, allowing simple and rapid signal transmission. In other words, the described structure enables efficient input/output switching of a plurality of signal lines.

FIG. 5 is a diagram illustrating a specific example of I/O paths formed depending on switching direction setting of a control logic circuit within a signal control apparatus in an access control system according to one or more embodiments of the present disclosure. Here, the control logic circuit may be or correspond to the control logic circuit shown in FIG. 4.

Referring to FIG. 5, the control logic circuit includes a switching logic circuit, i.e., a bidirectional block, and is configured to automatically detect whether a communication method is based on a Wiegand protocol or an OSDP protocol, and operate in a mode corresponding to the detected communication protocol. To achieve this, the control logic circuit may be implemented based on an MCU and may be configured to include an OSDP/Wiegand auto detection circuit, a bidirectional block, an alarm and output circuit, data lines (signal lines), and a connector.

First, the MCU controls signal flow by managing output and input ports and activates a switching circuit via CNT1 to CNT4 signals and EN_AB and EN_CD signals.

In the meantime, the OSDP/Wiegand auto detection circuit automatically detects whether the communication method is based on the Wiegand protocol or the OSDP protocol and sets an appropriate mode. Based on the detection result, the MCU sets the switching direction (signal direction).

Additionally, the bidirectional block corresponds to the switching logic circuit indicated by the boxed section and sets the switching direction of ports A, B, C, and D depending on Logic 1 or Logic 0. At this time, the MCU may activate the switching direction using EN_AB and EN_CD signals.

For example, in the Wiegand mode, the MCU controls the EN_AB and EN_CD signals to activate a signal line (D0/D1) path and switches Logic I/O to set Data 1 to Data 4 as Wiegand signals.

In contrast, in the OSDP mode, the MCU deactivates the Wiegand signal path by controlling the EN_AB and EN_CD signals and sets the communication to use RS-485-based OSDP protocol. In this case, because the output ports (at least one output port provided for notifications) previously used for Wiegand mode are no longer needed, at least some of those output ports may be converted into input ports to receive other signals. In other words, the output ports are repurposed for other functions to avoid being wasted.

The alarm input/output circuit may transmit control commands and/or control signals through the output circuit based on specific input conditions, and may be connected to output ports and used to control access restriction devices, alarm devices, and the like.

In addition, the data line is used for signal transmission and reception with the reader 400 and external devices. In the Wiegand mode, D0/D1 type signals can be directly transmitted through the data line. However, in the OSDP mode, data packets may be transmitted based on the RS-485 protocol.

Meanwhile, the connector may be connected to additional peripheral devices such as a buzzer and an LED, which can be controlled through the output ports.

Hereinafter, the control flow will be described in detail based on Table 1 below.

TABLE 1

| MODE | EN_AB | EN_CD | CNT1&CNT2 | CNT3&CNT4 | Signal Flow |
|---|---|---|---|---|---|
| OSDP | 1 | 0 | 1 | x | Data1 → Port A → Port A′ → Data2 |
| OSDP | 1 | 1 | 1 | 1 | Data1 → Port A → Port A′ → Data2 |
| | | | | | Data3 → Port C → Port C′ → Data4 |
| OSDP | 1 | 1 | 1 | 0 | Data1 → Port A → Port A′ → Data2 |
| | | | | | Data4 → Port D′ → Port D → Data3 |
| OSDP | 1 | 1 | 0 | 1 | Data2 → Port B′ → Port B → Data1 |
| | | | | | Data3 → Port C → Port C′ → Data4 |
| Wiegand | 1 | 1 | 0 | 0 | Data2 → Port B′ → Port B → Data1 |
| | | | | | Data4 → Port D′ → Port D → Data3 |

Table 1 illustratively shows how the EN and CNT signal setting values affect the operation of the FLEX ports according to each operation mode (Wiegand/OSDP).

In particular, in the OSDP mode, each port such as LED (F1) and BUZZ (F2) can be independently configured as either an input or output. Accordingly, the operation direction of the Mux/DeMux and the signal path of the ports are switched in real time.

For example, case 1 corresponds to the OSDP mode where only the LED/F1 port is used as an input. In this case, the settings are EN_AB=1, EN_CD=0, and CNT1 & CNT2=0, but CNT3 & CNT4 are not used, resulting in an input path such as Data1→Port A→Port A′→Data2. In addition, case 2 corresponds to the OSDP mode where all Buzz/F2 ports are used as inputs. The settings are EN_AB=1, EN_CD=1, CNT1 & CNT2=1, and CNT3 & CNT4=1, resulting in two input paths such as Data1→Port A→Port A′→Data2, and Data3→Port C→Port C′→Data4. On the other hand, case 3 corresponds to the OSDP mode where the LED/F1 port is used as an input and the Buzz/F2 port as an output. The settings are EN_AB=1, EN_CD=1, CNT1 & CNT2=1, and CNT3 & CNT4=0, resulting in an input path such as Data1→Port A→Port A′→Data2, and an output path such as Data4→Port D′→Port D→Data3. In addition, case 4 corresponds to the OSDP mode where the LED/F1 port is used as an output and the Buzz/F2 port as an input. The settings are EN_AB=1, EN_CD=1, CNT1 & CNT2=0, and CNT3 & CNT4=1, resulting in an output path such as Data2→Port B′→Port B→Data1, and an input path such as Data3→Port C→Port C′→Data4.

On the other hand, case 5 corresponds to the Wiegand mode in which both the LED/F1 port and the Buzz/F2 port are used as input. When EN_AB=1, EN_CD=1, CNT1 & CNT2=0, and CNT3 & CNT4=0 are set, input paths such as Data2→Port B′→Port B→Data1, and Data4→Port D′→Port D→Data3 may be formed.

FIGS. 4 and 5 described above illustrate an example in which the control logic circuit is implemented based on an MCU. However, it may alternatively be implemented by a CPU and is not limited thereto.

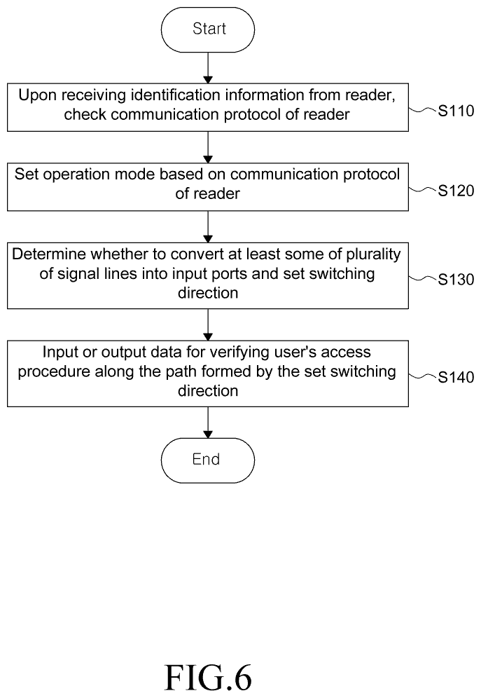

FIG. 6 is a flowchart schematically illustrating a signal control method in an access control system according to one or more embodiments of the present disclosure. Here, the access control system may be or correspond to the access control system of FIG. 1.

Referring to FIG. 6, when identification information of a user is received from the reader 400 installed in a designated area, the processor 340 verifies the communication protocol used by the specific reader (S110). At this time, the communication protocol may be identified based on whether the OSDP/Wiegand auto-detection circuit described above detects the use of a Wiegand-based protocol or an OSDP-based protocol.

Subsequently, the processor 340 sets an operation mode to either a Wiegand mode or an OSDP mode based on the communication protocol of the reader 400 identified in step S110 (S120). That is, if the reader 400 uses a Wiegand-based communication protocol, the operation mode is set to the Wiegand mode, and if it uses an OSDP-based protocol, the operation mode is set to the OSDP mode.

Then, based on the operation mode set in step S120, the processor 340 determines whether at least some of the plurality of signal lines are to be converted into input ports (S130). In this case, in the Wiegand mode, it is determined to use the plurality of signal lines as they are, whereas in the OSDP mode, it is determined to convert at least some of the output ports among the plurality of signal lines, which are provided for notifications, into input ports for use.

Next, the processor 340 sets a switching direction of the control logic circuit according to the determination in step S130, and inputs or outputs data for verifying the user's access procedure to the designated area through the plurality of signal lines (S140).

In particular, in the Wiegand mode, the processor 340 may be configured to output data using all output ports without changing the switching direction of the control logic circuit.

Meanwhile, in the OSDP mode, the processor 340 may be configured to change the switching direction of the control logic circuit to convert at least some of the output ports, provided for notifications, into input ports for receiving data, while outputting data through the remaining output ports.

Additionally, when the access verification procedure is completed in step S140, the operation may be terminated and the system may wait for the next request (reception of the next identification information).

Although not illustrated in FIG. 6, in step S110, the identification information received from the reader 400 may be transmitted to the central server 100, and in response, verification information regarding the user's access to a designated area may be received.

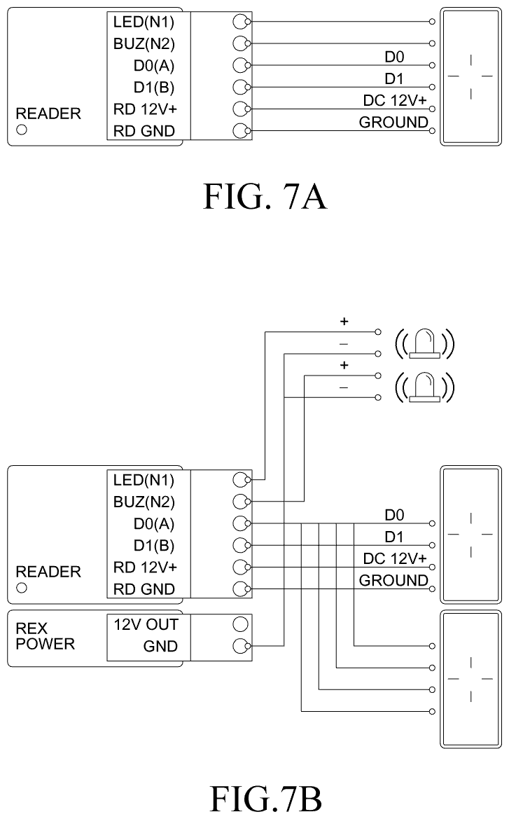

FIGS. 7A and 7B are diagrams illustrating examples of signal pin usage in the Wiegand mode and in the OSDP mode, respectively, according to one or more embodiments of the present disclosure.

FIG. 7A illustrates an example of using signal pins in the Wiegand mode, where a total of six signal lines may be provided as a plurality of signal lines. For example, the plurality of signal lines may include D0(A) and D1(B) which are used by the reader 400 to transmit data to the signal control apparatus 300, LED(N1) which is used by the signal control apparatus 300 to control the LED of the reader 400, BUZ(N2) which is used by the signal control apparatus 300 to control the buzzer of the reader 400, and RD 12V+ and RD GND which are used to supply power to the reader 400.

When a user wishing to access a designated area presents an identification means to the reader 400 installed at that area, the reader 400 operating in the Wiegand mode transmits Wiegand data (identification information) to the signal control apparatus 300 through the D0 and D1 signal lines. The signal control apparatus 300 may directly verify the identification information or verify the identification information via the central server 100 to determine whether to allow access. Accordingly, when access is granted or denied, a notification may be provided by turning on the LED or activating the buzzer of the reader 400 through LED(N1) and/or BUZ(N2) to control the LED and/or buzzer installed in the reader 400.

Meanwhile, FIG. 7B illustrates an example of using signal pins in the OSDP mode, where data is transmitted and received based on a data packet transmission method through RS signal lines A(RS485+) and B(RS485−) for bidirectional data communication. In this case, at least some of the signal lines for LED(N1) and BUZ(N2), among a plurality of signal lines, may be converted into input ports and used as such. Meanwhile, RD 12V+ and RD GND are used to supply power to the reader, as in the Wiegand mode.

When a user intending to access a designated area presents an identification means to a reader 400 provided in the designated area, data may be transmitted and received between a signal control apparatus 300 and the reader 400 through bidirectional communication via RS-485 in the OSDP mode. In this case, the signal control apparatus 300 may enhance security by transmitting and receiving encrypted verification information with the reader 400. In addition, the signal control apparatus 300 may determine whether to permit access by directly verifying identification information or by verifying the identification information through a central server 100. Accordingly, when access is permitted or denied, the signal control apparatus 300 may directly transmit a buzzer control signal and/or an LED control signal to the reader 400. Furthermore, the signal control apparatus 300 may also directly control an access restriction device or other equipment through RS-485 communication.

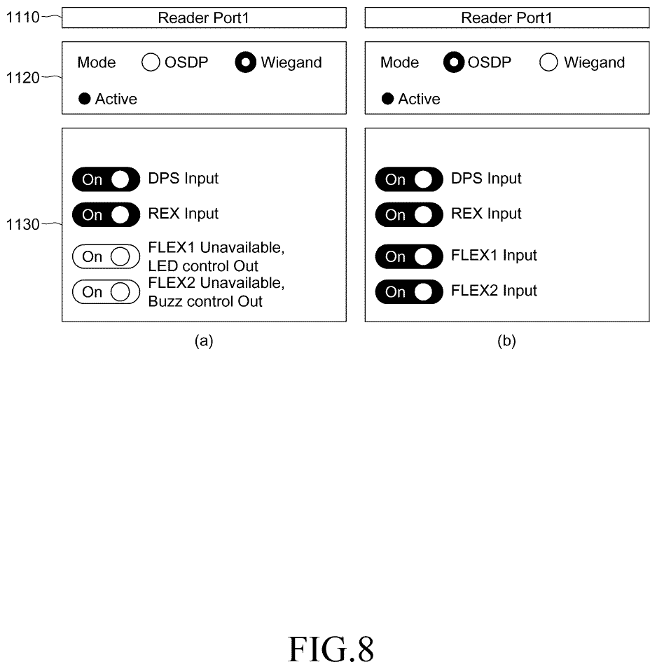

FIG. 8 is a diagram illustrating an example of a user interface screen implemented to allow a user to visually check an operation status of a signal control apparatus in an access control system according to one or more embodiments of the present disclosure. Here, the signal control apparatus may be or correspond to the signal control apparatus 300 of FIG. 2.

Referring to FIG. 8, the user interface may be configured to allow administrators, managers, or system operators to intuitively check the terminal information, operating mode information, and status information of each port and easily adjust the settings if necessary. To this end, a user interface screen may include at least one setting display window 1110, 1120, 1130 for displaying such information.

FIG. 8A illustrates a state set to the Wiegand mode, and FIG. 8B illustrates a state set to the OSDP mode.

In the Wiegand mode, the FLEX1 and FLEX2 ports are set as output ports for LED and BUZZ control, respectively, and since these ports are not used as an input function, they are indicated as ‘Unavailable’ in an input state.

In contrast, in the OSDP mode, the same ports are converted into input ports and displayed as active status, and basic input ports such as DPS input and REX input are also activated.

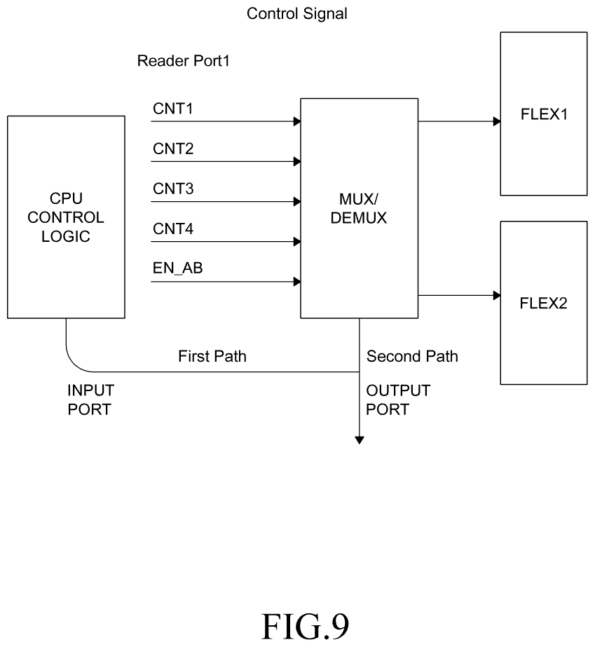

FIG. 9 is a diagram illustrating a circuit structure in which I/O directions of FLEX ports are dynamically switched in response to control signals during operation in the OSDP mode in an access control system, according to one or more embodiments of the present disclosure. Here, the access control system may be or correspond to the access control system 100 shown in FIG. 1.

Referring to FIG. 9, control signals (CNT1 to CNT4, EN_A) generated by a control logic circuit, which may be a CPU (or MCU), are delivered to a Mux block and a DeMux block, and input/output directions of FLEX1 and FLEX2 ports are dynamically set. In FIG. 9, for convenience of illustration, the Mux block and the DeMux block are depicted as a single block (′MUX/DEMUX′). However, in actual implementations, the Mux block and the DeMux block may be configured as two independent blocks.

A first path represents an input path through which signals flowing in from the FLEX ports are transmitted to the CPU (or MCU) via the Mux block and the DeMux block. For example, this includes a case in which FLEX1 operates as an input port receiving signals from an external sensor.

In contrast, a second path represents an output path through which data transmitted from the CPU (or MCU) is delivered to the FLEX ports via the Mux block and the DeMux block. For example, this includes a case in which FLEX2 operates as an output port for controlling a buzzer or LED.

Through such a configuration, in the OSDP mode, each port may flexibly switch between input and output based on control signals, enabling integration with various sensors and notification devices without the need for additional hardware. Accordingly, the present disclosure enables the advantages of both Wiegand-based and OSDP-based protocols to be combined, thereby satisfying requirements for both security and scalability. In particular, by converting unused output ports into input ports in the OSDP mode, the utilization of signal lines is improved, allowing additional input functions to be provided to users without increasing hardware costs.

Although the present disclosure has been described in detail with reference to the accompanying drawings through above example embodiments, it should be understood that the present disclosure is not limited to these embodiments. Various modifications and variations may be made without departing from the scope of the technical spirit of the present disclosure. Accordingly, the embodiments disclosed in the present disclosure are intended to illustrate, not to limit the technical spirit of the present disclosure and the scope of the technical spirit of the present disclosure should not be construed as limited by these embodiments. Therefore, the embodiments described above are to be understood as illustrative and not restrictive in all respects. The scope of protection of the present disclosure should be interpreted by the following claims, and all technical ideas within the equivalent scope thereof should be construed as being included within the scope of rights of the present disclosure.

What is claimed is:

1. A method for controlling signals in an access control system, performed by an apparatus, the method comprising:
identifying a communication protocol used by a reader upon receiving identification information from the reader disposed in a designated area;
setting an operation mode to one of a plurality of modes based on the communication protocol of the reader;
determining whether to convert at least some of signal lines connected as output ports among a plurality of signal lines into input ports based on the set operation mode, and setting a switching direction of a control logic circuit; and
inputting or outputting data required for a user's access verification procedure to the designated area through a path formed by the set switching direction.

2. The method of claim 1, wherein the plurality of modes comprise a Wiegand mode or an Open Supervised Device Protocol (OSDP) mode.

3. The method of claim 2, wherein the determining whether to convert the at least some of the signal lines into the input ports comprises controlling the control logic circuit to convert the at least some of the signal lines into the input ports based on the set operation mode being the OSDP mode.

4. The method of claim 2, wherein, the inputting or outputting the data comprises outputting the data by using all the signal lines as the output ports through a path formed by maintaining the switching direction of the control logic circuit in a default direction based on the set operation mode being the Wiegand mode.

5. The method of claim 2, wherein, the inputting or outputting the data comprises:
receiving the data through a path formed by converting the at least some of the signal lines into the input ports by changing the switching direction of the control logic circuit; and
outputting the data by using remaining output ports through a path based on the set operation mode being the OSDP mode.

6. The method of claim 1, further comprising restoring the set switching direction to a default direction based on a predetermined time or a predetermined condition, based on the at least some of the signal lines having been converted into the input ports.

7. The method of claim 1, wherein at least some of the output ports are configured to provide notifications through a notification device.

8. The method of claim 1, wherein the data input through the converted input ports comprises at least one of authentication history information of the user, status information of at least one of the reader and an access restriction device connected to the reader, and environmental information surrounding the designated area.

9. The method of claim 1, wherein the control logic circuit is implemented based on a microcontroller unit (MCU), and the switching direction of the control logic circuit is automatically changed in response to a control signal generated based on the communication protocol.

10. A signal control apparatus in an access control system, comprising:
a communication interface;
a memory; and
a processor operably connected to the communication interface and the memory, and wherein the processor is configured to:
identify a communication protocol used by a reader upon receiving identification information from the reader disposed in a designated area;
set an operation mode to one of a plurality of modes based on the communication protocol of the reader;
determine whether to convert at least some of signal lines connected as output ports among a plurality of signal lines into input ports based on the set operation mode, and set a switching direction of a control logic circuit; and
input or output data required for a user's access verification procedure to the designated area through a path formed by the set switching direction.

11. The signal control apparatus of claim 10, wherein the plurality of modes comprise a Wiegand mode or an Open Supervised Device Protocol (OSDP) mode.

12. The apparatus of claim 11, wherein the processor is configured to, when determining whether to convert the at least some of the signal lines into the input ports, control the control logic circuit to perform the conversion based on the set operation mode being the OSDP mode, such that the at least some of the signal lines are converted into the input ports.
